(19) United States
(12) Patent Application Publication
(10) Pub. No.: US 2020/0231373 A1
(43) Pub. Date: Jul. 23, 2020

(54) COFFEE CAPSULE WITH TWO-STAGE FILTERING MECHANISM

(71) Applicant: Hongjiang Liu, Shenzhen (CN)

(72) Inventor: Hongjiang Liu, Shenzhen (CN)

(21) Appl. No.: 16/255,646

(22) Filed: Jan. 23, 2019

(51) Int. Cl. B65D 85/804; B01D 29/35

(52) U.S. Cl. CPC B65D 85/8046; B01D 29/35

(57) ABSTRACT

In one aspect, a two-stage filter coffee capsule may include an outer cup, a second-stage filter mesh, an inner cup, a first-stage filter mesh, cup cover and a water inlet, wherein a second-stage filter mesh is disposed at an inner portion of the outer cup, and an inner cup is disposed in the outer cup, a first-stage filter mesh is disposed at the inner portion of the inner cup, and a cup cover is provided at a top surface of the inner cup. In one embodiment, the water inlet is disposed in a middle portion of the cup cover. In another embodiment, the outer cup is movably connected with the inner cup, and a decompression chamber is disposed between the outer cup and inner cup.

### FIELD OF THE INVENTION

The present invention relates to a coffee capsule, and in particular to a coffee capsule with two-stage filtering mechanism.

### BACKGROUND OF THE INVENTION

Currently, most filter coffee capsules available in the existing markets only have one layer of filter screen. When brewing coffee, the hot water with pressure enters the coffee capsule, and because the water coming out of the coffee machine has great water pressure, some coffee powder will be forced out of the capsule from meshes of the filter screen under the water pressure, the filtered coffee will be mixed with some coffee powder, which causes poor filtering effect and flavor. In order to achieve better filtering effect, some users add a filter cup to the filter capsule. Although the filtering effect is achieved, a number of filter paper cups will be used annually as the filter paper cup is disposable, which may cause a great environmental problem. Therefore, there remains a need for a new and improved coffee capsule to overcome the problems stated above.

### SUMMARY OF THE INVENTION

In one aspect, a two-stage filtering coffee capsule may include an outer cup, a second-stage filter mesh, an inner cup, a first-stage filter mesh, a cup cover and a water inlet, wherein the second-stage filter mesh is disposed at an inner side of the outer cup, and the inner cup is disposed in the outer cup, the first-stage filter mesh is disposed at an inner side of the inner cup, and a cup cover is provided at a top surface of the inner cup. In one embodiment, the water inlet is disposed in the middle portion of the cup cover. In another embodiment, the outer cup is movably connected with the inner cup, and a decompression chamber is disposed between the inner cup and the outer cup.

Compared with the conventional coffee capsules, the present invention is advantageous because the two-stage filtering coffee capsule is convenient to use, and can effectively filter the coffee grounds with the arrangement of the outer cup, second-stage filter mesh, inner cup, first-stage filter mesh, and cup cover. When using, open the cup cover on the top of the inner cup, add coffee powder to the inner cup with the first-stage filter mesh on the inner portion, cover the cup cover, and assemble the inner cup with coffee powder in the outer cup with the second-stage filter mesh. Open the coffee machine, place the two-stage filter coffee capsule in the coffee machine. After starting the coffee machine, the hot water with pressure in the coffee machine will enter the coffee powder in the inner cup from the water inlet in the middle of the cup cover, and after mixing with the coffee powder, the coffee liquid comes out of the first-stage filter mesh and enters the decompression chamber between the inner cup and the outer cup. Before the coffee liquid enters the decompression chamber, as the water in the inner cup is still with certain pressure, some fine coffee powder will enter the decompression chamber with the coffee liquid by passing through the first-stage filter mesh under the water pressure. At this time, the coffee liquid with fine coffee powder in the decompression chamber undergoes a secondary filtration through the second-stage filter mesh inside the outer cup. In the decompression chamber, the water pressure of coffee liquid becomes smaller. Also, the mesh hole size of the second-stage filter mesh is smaller so the fine coffee powder in the decompression chamber can be retained while the coffee liquid is filtered out. Thus, a cup of well-filtered coffee with great taste can be prepared.

### BRIEF DESCRIPTION OF THE DRAWINGS

FIG. 1 illustrates an exploded view of the structure of the coffee capsule with two-stage filtering mechanism in the present invention.

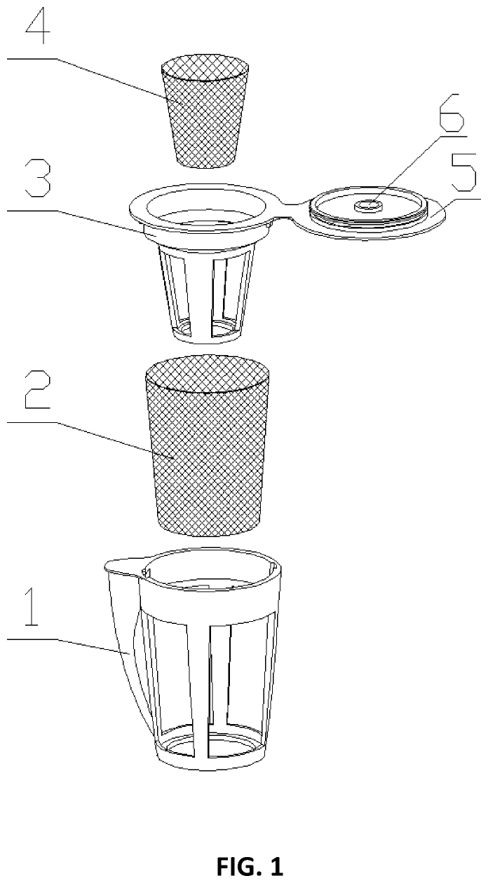

FIG. 2 illustrates a cross-sectional view of the structure of the coffee capsule with two-stage filtering mechanism in the present invention

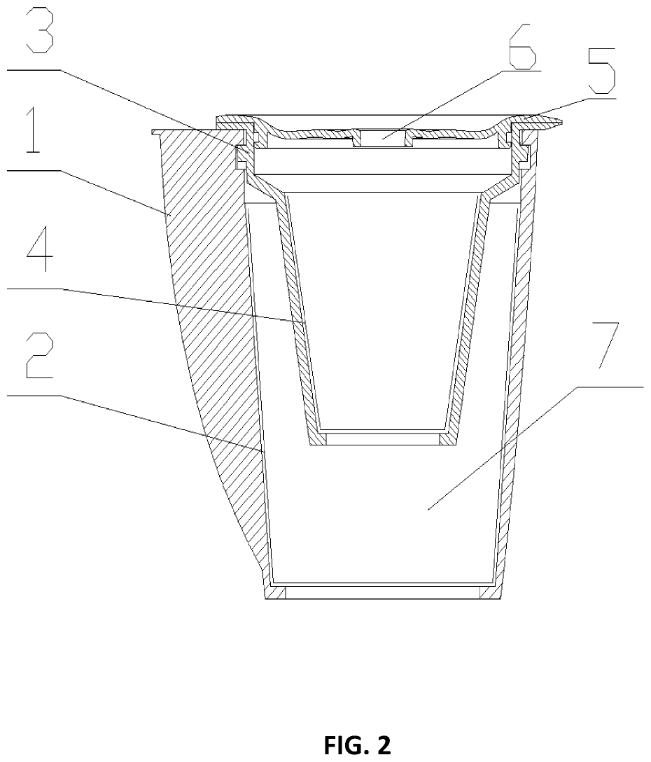

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In one aspect, a two-stage filter coffee capsule, comprising an outer cup 1, a second-stage filter mesh 2, an inner cup 3, a first-stage filter mesh 4, cup cover 5 and a water inlet 6, wherein a second-stage filter mesh 2 is disposed at an inner portion of the outer cup 1, and an inner cup 3 is disposed in the outer cup, a first-stage filter mesh 4 is disposed at the inner portion of the inner cup 3, and a cup cover 5 is provided at a top surface of the inner cup 3.

In one embodiment, the water inlet 6 is disposed in a middle portion of the cup cover 5. In another embodiment, the outer cup 1 is movably connected with the inner cup 3, and a decompression chamber 7 is disposed between the outer cup 1 and inner cup 3.

Compared with the conventional coffee capsules, the present invention is advantageous because the two-stage filtering coffee capsule is convenient to use, and can effectively filter the coffee grounds with the arrangement of the outer cup, second-stage filter mesh, inner cup, first-stage filter mesh, and cup cover. When using, open the cup cover 5 on the top of the inner cup 3, add coffee powder to the inner cup 3 with the first-stage filter mesh 4 on the inner portion, cover the cup cover 5, and assemble the inner cup 3 with coffee powder in the outer cup 1 with the second-stage filter mesh 2. Open the coffee machine, place the two-stage filter coffee capsule in the coffee machine. After starting the coffee machine, the hot water with pressure in the coffee machine will enter the coffee powder in the inner cup 3 from the water inlet 6 in the middle portion of the cup cover 5, and after mixing with the coffee powder, the coffee liquid comes out of the first-stage filter mesh 4 and enters the decompression chamber 7 between the inner cup 3 and the outer cup 1. Before the coffee liquid enters the decompression chamber 7, as the water in the inner cup 3 is still with certain pressure, some fine coffee powder will enter the decompression chamber 7 with the coffee liquid by passing through the first-stage filter mesh 4 under certain water pressure. At this time, the coffee liquid with fine coffee powder in the decompression chamber 7 undergoes a secondary filtration through the second-stage filter mesh 2 inside the outer cup 1. In the decompression chamber 7, the water pressure of coffee liquid becomes smaller. Also, the mesh hole size of the second-stage filter mesh 2 is smaller so the fine coffee powder in the decompression chamber 7 can be retained while the coffee liquid is filtered out. Thus, a cup of well-filtered coffee with great taste can be prepared.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A coffee capsule with two-stage filtering mechanism comprising an outer cup, a second-stage filter mesh, an inner cup, a first-stage filter mesh, a cup cover and a water inlet, wherein the second-stage filter mesh is disposed at an inner side of the outer cup, and the inner cup is disposed in the outer cup, the first-stage filter mesh is disposed at an inner side of the inner cup, and a cup cover is provided at a top surface of the inner cup.

2. The coffee capsule with two-stage filtering mechanism of claim 1, wherein the water inlet is disposed in a middle portion of the cup cover.

3. The coffee capsule with two-stage filtering mechanism of claim 1, wherein the outer cup is movably connected with the inner cup, and a decompression chamber is disposed between the inner cup and the outer cup.
